(19) United States
(12) Patent Application Publication
(10) Pub. No.: US 2003/0048007 A1
(43) Pub. Date: Mar. 13, 2003

(54) Electronic power management system

(76) Inventors: Claude Mercier, Perkasie, PA (US); Simon Cordner, Voorhees, NJ (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 10/238,512

(22) Filed: Aug. 29, 2002

Related U.S. Application Data
(60) Provisional application No. 60/318,187, filed on Sep. 7, 2001.

(51) Int. Cl. H02H 1/00

(52) U.S. Cl. 307/125

(57) ABSTRACT

An electronic power management system includes at least one power distribution unit, a control panel, and at least one data bus. The power distribution unit distributes electrical power to at least one electric load and provides status of each electrical load and characteristics of the electrical power. The control panel receives the status and electrical power characteristics and controls operation of the electrical loads in response to the status and electrical power characteristics. The data bus communicatively couples the control panel and the power distribution units. The electrical characteristics for each load include measured electric current and voltage values, and an indication as to whether measured values are over, under, within a range, or out of a range of threshold values.

### CROSS-REFERENCE TO RELATED APPLICATION

The present application claims priority to U.S. Provisional Application Serial No. 60/318,187, filed Sep. 7, 2001, entitled “Electronic Power Management System,” the entirety of which is incorporated herein by reference.

### FIELD OF THE INVENTION

The present invention relates to power management systems, and specifically to a power management system for aircraft and marine platforms.

### BACKGROUND

Typical marine and aerospace platforms have numerous electrical loads located along the full length of the hull on both the starboard and port sides. Examples of electrical loads include motors, pumps, air conditioners, radar equipment, navigation equipment, fathometers, altimeters, entertainment centers, refrigerators, and propeller heaters. Electrical power is typically supplied to these electrical loads from a common power source by heavy gauge electrical conductors.

FIG. 1 illustrates the electrical path from a power source to an electrical load used in a typical aerospace platform. The power source 2 is a 28 Vdc supply. The current supplied by power source 2 to propeller heater 12 flows through thermal breaker 4, and timer 10. Timer 10 is controlled by the weight on wheels switch 8. When weight on wheels switch 8 is open, indicating that no weight is on the wheels of the aircraft, timer 10 is enabled. Enabled timer 10 allows electrical current to flow to propeller heater 12 for a predetermined amount of time.

The system depicted in FIG. 1 has several disadvantages. A typical propeller heater 12 has a nominal current rating of 25 amperes. Accordingly, a thermal breaker 4 rated for a nominal current of 25 amperes, is typically implemented. However, due to inherent limitations of thermal heaters, a heavier gauge electrical conductor, than is required for 25 amperes, must be used. This heavier gauge conductor must be used throughout the portion of the circuit in which current flows from power source 2 to propeller heater 12. The weight of heavier gauge conductors is a considerable disadvantage on aerospace platforms. Further, large gauge electrical conductors (e.g., wires) connected between rocker switches to breakers create cumbersome harness bundles that complicate aircraft wiring and also increase weight, labor and materials costs.

Thermal switches also possesses disadvantages. Thermal switches are typically tripped when the temperature of the switch exceeds a predetermined value. Thus, amperage rates vary considerably with ambient temperature. For example, a 25 ampere thermal switch subjected to twice its rated current (i.e., 50 amperes) may not trip for as long as 30 seconds under extreme temperature conditions.

Other disadvantages of the scheme in FIG. 1 include the fact that breakers and indicators are often not co-located. Thus, no central alerting mechanism exists to provide warnings of non-functioning circuits. An operator or technician must attend each breaker site to determine if a malfunction in the breaker has occurred.

Further, in cases where heavy gauge wire is connected to instruments on a control panel, heavy current near the instruments may adversely effect the accuracy of readings. Thus, a need exists for a power management system, which overcomes the above disadvantages.

### SUMMARY OF THE INVENTION

An electronic power management system includes at least one power distribution unit, a control panel, and at least one data bus. The power distribution unit distributes electrical power to at least one electric load. The power distribution unit also provides status of each electrical load and characteristics of the electrical power. The control panel receives the status and electrical power characteristics and controls operation of the electrical loads in response to the status and electrical power characteristics. The data bus communicatively couples the control panel and the power distribution units.

### BRIEF DESCRIPTION OF THE DRAWINGS

The invention is best understood from the following detailed description when read in connection with the accompanying drawing. The various features of the drawings may not be to scale. Included in the drawing are the following figures:

FIG. 1 (Prior Art) is a diagram illustrating the electrical path from a power source to an electrical load used in a typical aerospace platform;

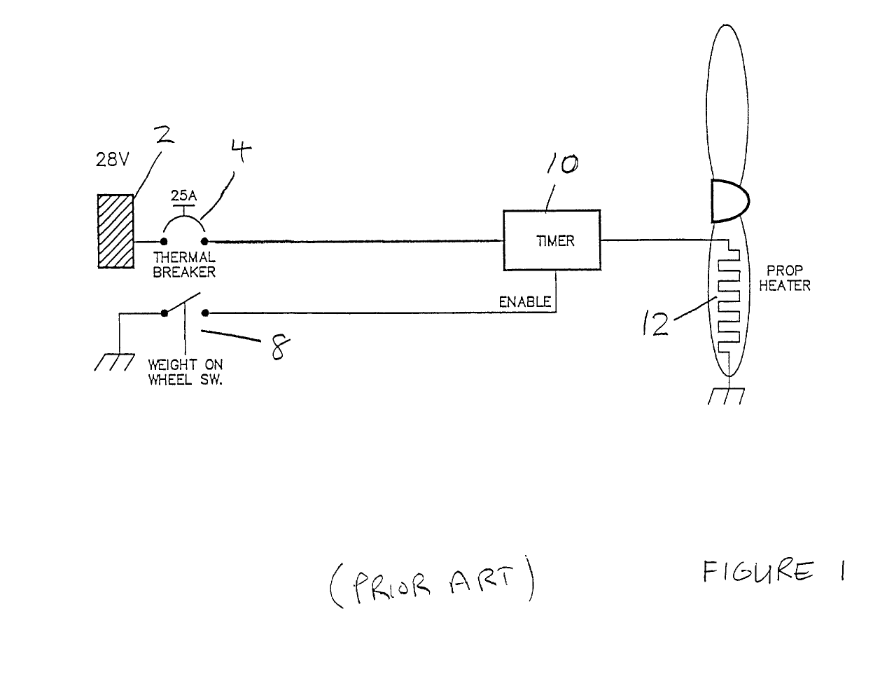

FIG. 2 is an illustration of an exemplary electronic power management system in accordance with the present invention;

FIG. 3 is an illustration of an exemplary control panel in accordance with the present invention;

FIG. 4 is a diagram illustrating an exemplary distribution unit in accordance with the present invention;

FIG. 5 is a functional block diagram of an exemplary embodiment of a power distribution module in accordance with the present invention;

FIG. 6 is a functional block diagram of another exemplary embodiment of a power distribution module in accordance with the invention;

FIG. 7 is a diagram of an exemplary safety switch in accordance with the present invention.

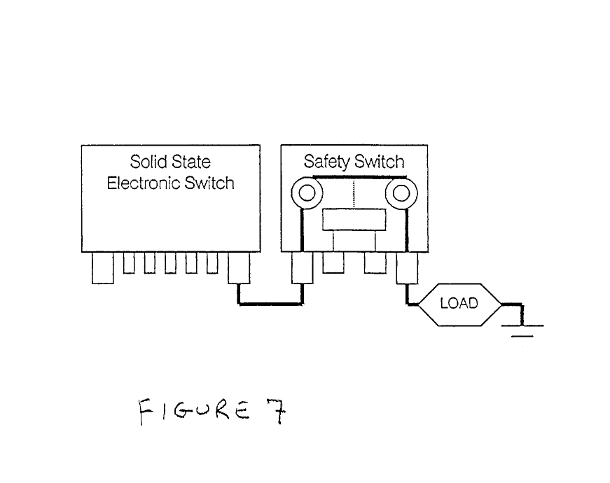

### DETAILED DESCRIPTION OF THE INVENTION

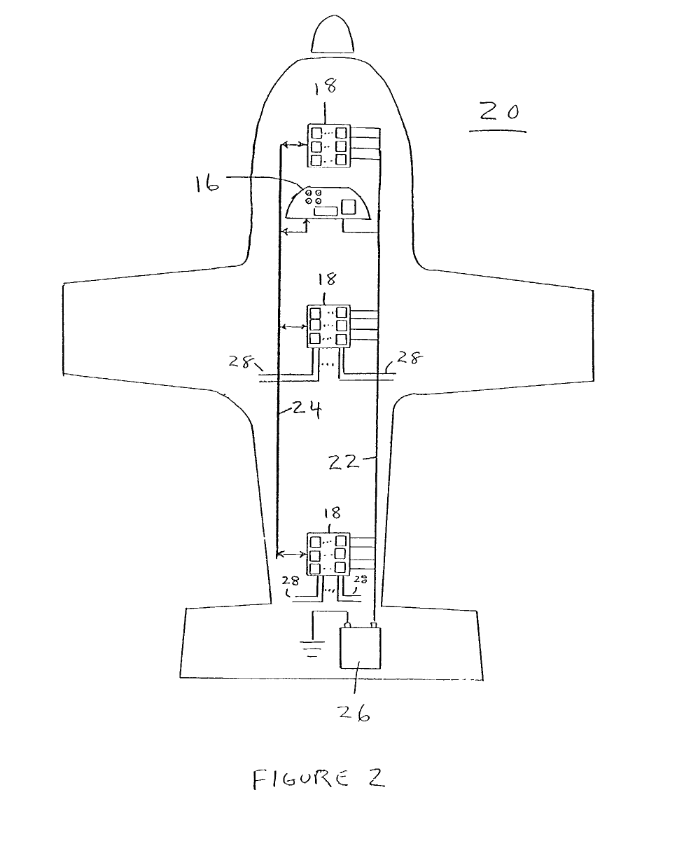

FIG. 2 is an illustration of an exemplary electronic power management system in accordance with the present invention. The electronic power management system, generally designated 20, comprises control panel 16, power distribution unit 18, power source 26, and data bus 24. The platform depicted in FIG. 2 is a propeller-powered aircraft. This depiction is exemplary. The platform may be any appropriate platform such as a propeller-powered aircraft, jet aircraft, spacecraft, land vehicle, and marine vessel.

Conductors 28 are electrically coupled to loads (loads not shown in FIG. 2) located throughout the platform. Each load may be any load using electricity, such as motors, pumps, air conditioners, radars, navigation lights, entertainment centers, refrigerators, propeller heaters, fathometers, altimeters, and valves. Conductors 28 provide a conductive path for power to the loads. Power is supplied by power source 26. Power source 26 may be any appropriate power source, such as a generator or a battery. In an exemplary embodiment of the invention, power source 26 is a 28 Vdc power supply. Power is provided to power distribution units 18 and control panel 16 by power source 26 through power bus 22. Power bus 22 may be a plurality of busses. Often, power sources are located at opposite ends of the platform and coupled by power busses (second power source not shown in FIG. 2).

Power supplied to the loads is monitored and controlled by distribution units 18 and control panel 16. Data bus 24 communicatively couples distribution units 18 with control panel 16. Data bus 24 may be a plurality of busses. Data bus 24 may be any appropriate serial or parallel bus. In an exemplary embodiment of the invention data bus 24 is a dual redundant control area network (CAN). A description of a control area networks may be found in U.S. Pat. No. 5,854,454 issued to Upender et al.

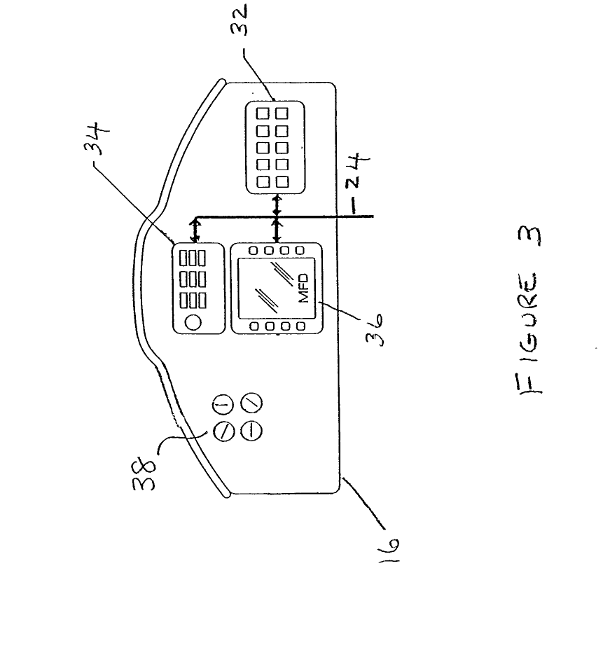

FIG. 3 is an illustration of an exemplary control panel in accordance with the present invention. Control panel 16 comprises instrument panel 38, annunciation panel 34, multi-function display panel 36, and switch panel 32. Control panel 16 may be used to monitor, control, and perform diagnostic tests on selected loads.

Annunciation panel 34 is communicatively coupled to data bus 24. Annunciation panel 34 receives and annunciates the status of the electrical loads. Load status is annunciated by messages such as pitot heat on, door ajar, propeller heat fail, fire detector fail, and low oil pressure, for example. These messages may be annunciated visually, aurally, or any combination thereof.

Multi-function display 36 is communicatively coupled to data bus 24. Multi-function display 36 displays load status and electrical characteristics of the electrical power of each load. The electrical characteristics for each load may include the measured electric current value, the measured electric voltage value, an indication that the measured electric current value is over a threshold value, an indication that the measured electric current value is under a threshold value, an indication that the measured electric current value is within a range of an upper threshold value and a lower threshold value, and an indication that the measured electric current value is out of range of an upper threshold value and a lower threshold value. Load status may include, for example, whether a door is opened or closed, whether a load is on or off, whether a load has failed, and whether pressure is low or high.

Switch panel 32 is communicatively coupled to data bus 24. Switch panel 32 controls selected loads by allowing an operator to turn a selected load on or off. The status pertaining to the on/off condition of a load is provided to data bus 24, and is thus available to all components coupled to data bus 24. Switch panel 32 may comprise any appropriate type switches, such as toggle switches and touch switches. In an exemplary embodiment of the invention, switch panel 32 comprises momentary type switches, which alternately turn a selected load on and off with each successive depression of the switch. In another embodiment of the invention, switch panel 32 comprises redundant circuitry and lightning protection circuitry.

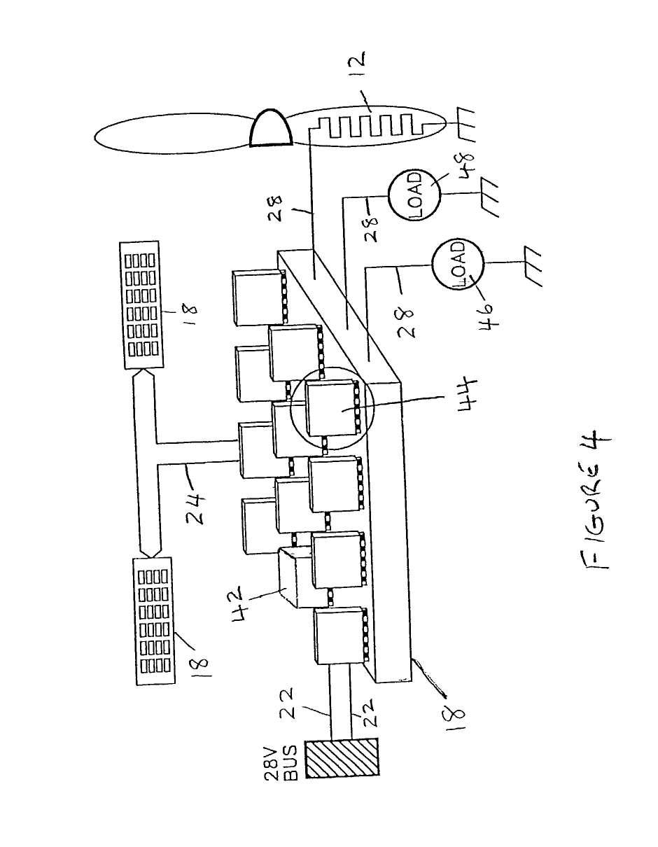

FIG. 4 illustrates an exemplary distribution unit in accordance with the present invention. Distribution unit 18 comprises microprocessor module 42 and power distribution modules 44. All modules shown coupled to power distribution unit 18, in FIG. 4, except microprocessor module 42, are power distribution modules 44. Only the encircled power distribution module is marked with the identification number 44 for clarification purposes. In an exemplary embodiment of the invention, power distribution modules 44 are modules adapted to be plugged into power distribution unit 18. Each power distribution module 44 comprises similar circuitry. Microprocessor module 42 is communicatively coupled to data bus 24 and electrically coupled to all power distribution modules 44. Microprocessor module 42 receives load control information from control panel 16 via data bus 24. In response to the load control information, microprocessor module 42 controls selected power distribution modules 44. Each selected power distribution module 44 distributes power to it respective load, in accordance with the load control information received form microprocessor module 42. Each power distribution module 44 is electrically coupled to a respective single load. Thus, in FIG. 4 one power distribution module 44 is coupled to load 46, another power distribution module 44 is coupled to load 48, and yet another power distribution module 44 is coupled to propeller heater 12.

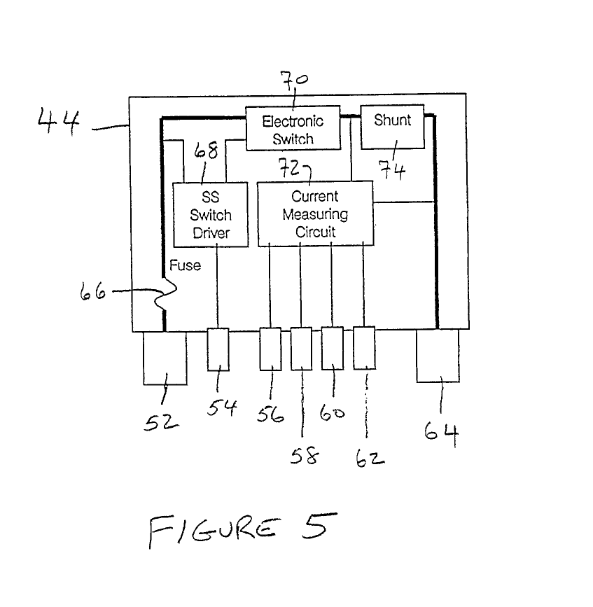

FIG. 5 is a functional block diagram of an exemplary embodiment of a power distribution module in accordance with the present invention. Power distribution module 44 comprises fusible link 66, switch driver 68, switch 70, current measuring circuit 72, and shunt 74. Terminals 52, 54, 56, 58, 60, 62, and 64 are adapted to be plugged in to power distribution unit 18. Terminal 52 is electrically coupled to power bus 22. Terminal 54 is electrically coupled to a switch control. Terminal 56 is electrically coupled to voltage provided by a power supply. Terminal 58 is electrically coupled to a low current flag. Terminal 60 is electrically coupled to a high current flag. Terminal 62 is electrically coupled to ground. Terminal 64 is electrically coupled to a load.

One end of fusible link 66 is electrically coupled to terminal 52, and the other end is electrically coupled to switch driver 68 and switch 70. Thus, power is available through fusible link 66 to switch 70 and switch driver 68. Switch driver 68 is also coupled to switch 70 and to terminal 54. Terminal 54 is electrically coupled to a switch control, which provides a switch control signal (switch control not shown in FIG. 5). The switch control is controllable by the operator, thus allowing the operator to manually control power to a selected load. In an exemplary embodiment of the invention, terminal 54 is coupled to switch panel 32 through data bus 24. In another exemplary embodiment of the invention, terminal 54 is directly, electrically coupled to an emergency switch panel (e.g., breaker panel) located other than on control panel 16.

Switch 70 is electrically coupled to switch driver 68, fusible link 66, current measuring device 72, and shunt 74. In an exemplary embodiment of the invention, switch 70 is an electronic switch. Current measuring device 72 is electrically coupled to both ends of shunt 74, and to terminals 56, 58, 60, 62, and 64. Shunt 74 is electrically coupled to switch 70, current measuring device 72, and terminal 64.

Power from power source 26 is distributed to selected electrical loads through power distribution modules 44. Fusible link 66 opens the conductive path when the electrical current flowing through the fusible link 66 exceeds the fusible link's rated value. The rated value of each fusible link 66 corresponds to the selected load, which is electrically coupled to terminal 64. Information indicating that fusible link 66 is open is provided to control panel 16 through data bus 24. The operator is provided an indication that the fusible link for a selected load is open by either the annunciation panel 34 or the multifunction display 36, or both.

The operator may manually control power to a selected load by providing a signal to switch driver 68 through terminal 54. Switch driver 68 opens and closes switch 70 in response to the switch control signal received from terminal 54. In one embodiment of the invention, power of provided to a selected load when switch 70 is open, in another embodiment of the invention, power is provided to a selected load when switch 70 is closed.

Current measuring device 72 and shunt 74 measure the current provided to the selected load (hereafter referred to as “selected load current”) through terminal 64. In an exemplary embodiment of the invention, shunt 74 is a resistive device. A voltage is developed across shunt 74 in response to the current flowing through shunt 74. The current measuring device 72 detects this voltage to determine the value of select load current. In another exemplary embodiment of the invention, shunt 74 is an electromagnetic device (e.g., coil), which produces a voltage in response to the electromagnetic field created by the current through shunt 74. The current measuring device 72 detects this voltage to determine the select load current.

In an exemplary embodiment of the invention, predetermined threshold values are stored in current measuring device 72. These threshold values are used to determine if the selected load current is within acceptable limits. Although not illustrated in FIG. 5, it is envisioned that power distribution module 44 may have one threshold value corresponding to a single current flag, or a plurality of threshold values corresponding to a plurality of current flags. If the selected load current is less than a first threshold value, a low current flag signal is provided to microprocessor module 42 through data bus 24 (i.e., low current flag is set). If the selected load current is greater than a second threshold value, a high current flag signal is provided (i.e., high current flag is set) to microprocessor module 42 through data bus 24. Microprocessor module 42 provides a switch control signal to switch driver 68 in response to the received high and low current flag signals. In an exemplary embodiment of the invention, microprocessor module 42 sends a switch control signal to switch driver 68, which opens switch 70, thus disabling electrical current to the selected load. Microprocessor module 42 also provides information pertaining to the status of the selected load current to control panel 16 via data bus 24. This status information includes selected load current less than a first threshold value (e.g., low current flag), selected load current greater than a second threshold value (e.g., high current flag), and selected load current greater than a first threshold value and less than a second threshold value (e.g., selected load current between low and high current flags). The operator may use this status information to control power distribution to the selected load.

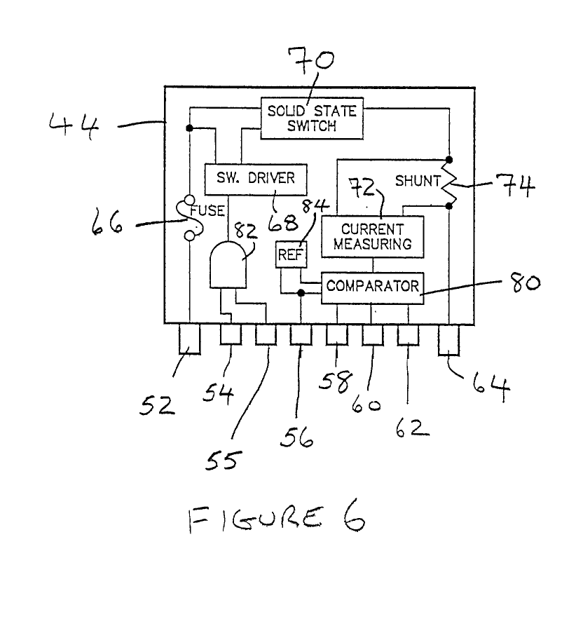

FIG. 6 is a functional block diagram of another exemplary embodiment of a power distribution module in accordance with the invention. In addition to the elements described in FIG. 5, the power distribution module of FIG. 6 includes terminal 55. Terminal 55 is adapted to be plugged in to power distribution unit 18. Terminal 55 is electrically coupled to a second switch control. This second switch control provides another means for the operator to control selected load current. Terminal 55 may be electrically coupled to a breaker panel located on the vehicle (breaker panel not shown), for example. Thus, in an exemplary embodiment of the invention, terminal 54 is electrically coupled to switch panel 32 and terminal 55 is electrically coupled to a breaker panel (breaker panel not shown). In an exemplary embodiment of the invention, both the first switch control signal (i.e., coupled to terminal 54) and the second control switch signal (i.e., coupled to terminal 55) are logic level high. These two switch control signals are provided to AND gate 82, which provides a logic level high signal to switch driver 68, thus closing switch 70, allowing electrical current to be provided to the selected load.

Comparator 80 compares the value of measured selected load current provided by current measuring device 72 with voltage reference 84. Voltage reference 84 is depicted as a single voltage reference, but in alternate embodiments of the invention, voltage reference 84 provides a plurality of voltage references. Thus, for example, one voltage reference is the first threshold value representing a low current flag, and a second voltage reference is the second threshold value representing a high current flag. The high and low current flags are set by the comparator in response to the results of the comparison. This information is provided to microprocessor module 42 and utilized as described with respect to FIG. 5. Shunt 74, in FIG. 6, is depicted as a resistive device. This depiction is exemplary. Shunt 74 may also be an electromagnetic device as described with respect to FIG. 5.

Although illustrated and described herein with reference to certain specific embodiments, the present invention is nevertheless not intended to be limited to the details shown. Rather, various modifications may be made in the details within the scope and range of equivalents of the claims and without departing from the spirit of the invention.

1. An electronic power management system comprising:
at least one power distribution unit for distributing electrical power to at least one electric load and for providing status of said at least one electrical load and for providing characteristics of said electrical power;
a control panel for receiving said status and said electrical power characteristics, wherein said control panel controls operation of said at least one electrical load in response to said status and electrical power characteristics; and
at least one data bus for communicatively coupling said control panel and said at least one power distribution unit.

2. An electronic power management system in accordance with claim 1 further comprising at least one power bus for providing said electrical power to said at least one power distribution unit.

3. An electronic power management system in accordance with claim 1 wherein said electrical power comprises 28 volts dc.

4. An electronic power management system in accordance with claim 1, wherein said control panel comprises:
at least one annunciator panel communicatively coupled to said data bus, wherein said at least one annunciator panel receives and annunciates said status; and
at least one multi-function display communicatively coupled to said data bus, wherein said at least one multi-function display receives and displays said status and said electrical power characteristics.

5. An electronic power management system in accordance with claim 4, wherein said control panel further comprises at least one switch panel for controlling operation of said at least one electrical load, wherein said at least one switch panel is communicatively coupled to said data bus.

6. An electronic power management system in accordance with claim 1, wherein said power distribution unit comprises:
at least one power distribution module, wherein each power distribution module controls said electrical power to a respective one of said at least one electrical load; and
at least one microprocessor module for receiving electrical load control information from said control panel, for controlling said at least one plug-in module, and for providing said status and said electrical power characteristics, wherein said at least one microprocessor module is communicatively coupled to said data bus.

7. An electronic power management system in accordance with claim 6, wherein said at least one plug-in module comprises:
a fuse electrically coupled between said electrical power and a switch;
said switch electrically coupled to said at least one microprocessor module, wherein said switch controls electrical current flow in response to said electrical load control information;
an electric current measuring circuit electrically coupled to said switch and to a respective one of said at least one electrical load, wherein said electric current measuring circuit provides electrical power characteristics information to said at least one microprocessor module.

8. An electronic power management system in accordance with claim 7, wherein said switch is selected from the group consisting of an electronic switch and a mechanical switch.

9. An electronic power management system in accordance with claim 1, wherein said electrical characteristics comprise at least one of measured electric current value, measured electric voltage value, measured electric current value is over a threshold value, measured electric current value is under a threshold value, measured electric current value is within a range of an upper threshold value and a lower threshold value, and measured electric current value is out of range of an upper threshold value and a lower threshold value.

10. An electronic power management system in accordance with claim 1 wherein said control panel provides an alarm when at least one of said electrical characteristics is at least one of under a first threshold value and over a second threshold value.

11. An electronic power management system in accordance with claim 1 further comprising a breaker panel coupled to at least one of said at least one electrical load for controlling said at least one of said at least one electrical load.

12. An electronic power management system in accordance with claim 1, wherein said data bus is a dual redundant control area network.

13. An electronic power management system in accordance with claim 1, wherein said at least one power distribution unit provides diagnostics data for display on said control panel, in response to said status and said electrical power characteristics.

14. An electronic power management system comprising:
a control panel for monitoring status and controlling operation of at least one electrical load, said control panel comprising:
at least one annunciator panel for providing said status of said at least one electrical load;
at least one multi-function display for displaying said status and for displaying electrical characteristics of electricity provided to said at least one electrical load, wherein said electrical characteristics comprise at least one of measured electric current value, measured electric voltage value, measured electric current value is over a threshold value, measured electric current value is under a threshold value, measured electric current value is within a range of an upper threshold value and a lower threshold value, and measured electric current value is out of range of an upper threshold value and a lower threshold value; and
at least one switch panel for controlling said operation of said at least one electrical load;
at least one power distribution unit for distributing electrical power to said at least one electric load; said power distribution unit comprising:
at least one power distribution module, wherein each power distribution module controls said electrical power to one of said at least one electrical load; and
at least one microprocessor module for controlling said at least one plug-in module;
at least one power bus for providing electrical power to said at least one power distribution unit; and
at least one data bus for providing communication between said control panel, said at least one annunciator panel, said at least one multi-function display, said at least one breaker panel, said at least on power distribution unit, and said at least one microprocessor module.
